(19) United States
(12) Patent Application Publication
(10) Pub. No.: US 2004/0165095 A1
(43) Pub. Date: Aug. 26, 2004

(54) Lens with infrared ray filter, method of manufacturing the same, and compact camera

(75) Inventors: Toshihiko Shimizu, Shiojirishi (JP); Ichiro Onishi, Suwa shi (JP); Akira Komatsu, Nagano ken (JP); Hiroshi Kojima, Okayashi (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/669,892

(22) Filed: Sep. 25, 2003

(30) Foreign Application Priority Data
Sep. 25, 2002 (JP) 2002-279296
Aug. 25, 2003 (JP) 2003-300043

(51) Int. Cl. H04N 5/225

(52) U.S. Cl. 348/335

(57) ABSTRACT

An infrared ray insulating dielectric multilayer film 3 for cutting infrared rays is provided on one of the surfaces of a glass plane-convex lens 2a, 2c having a flat refractive surface 21 on one side and a convex refractive surface 22 on the other side. A multi-cavity lens molding 26 having projections 24 of a convex lens integrally formed on the surface of a flat plate 25 is molded with glass, the infrared ray insulating dielectric multilayer film 3 is provided on either one of the surfaces of the multi-cavity lens molding 26, and the portion of the flat plate 25 of the multi-cavity lens molding 26 having the dielectric multilayer film 3 formed thereon is cut into individual projections 24. A lens with an infrared ray filter 1c which is obtained is used as a condenser for compact cameras. In this arrangement, there are provided a lens with an infrared ray filter and a method of manufacturing the same, and a compact camera, in which the cost, which becomes a problem when the lens with an infrared ray filter used as a condenser and the like for compact cameras is made of glass, may be reduced.

### FIELD OF THE INVENTION

The present invention relates to a lens with an infrared ray filter used for a compact camera to be built in a mobile phone or the like and a method of manufacturing the same and a compact camera using the lens with the infrared ray filter.

### DESCRIPTION OF THE RELATED ART

Recently, a compact camera is built in information technology devices such as mobile phones or laptop personal computers, so that image information taken by the compact camera can be obtained. An example of such compact camera is shown in FIG. 11.

As shown in FIG. 11, a compact camera 100 is provided with an electronic component 102 and a solid-state image sensing device module 103 mounted on a substrate 101, and a housing 106 having an IR (Infrared Ray) filter 105 being built in a lens barrel 104 is mounted to the substrate 101 so as to surround the solid-state image sensing device module 103. An outer cylindrical member 109 having an opening 107 which serves as aperture at one end, a condenser 108 assembled therein, and a thread formed on the inner surface thereof, is screwed into a thread formed on the outer surface of the lens barrel 104. By adjusting the amount of screw-in of the outer cylindrical member 109, the distance between the condenser 108 and the solid-state image sensing device module 103 can be adjusted for focusing. It is fixed by means of adhesive agent after adjustment. The opening 107, the lens barrel 104, the condenser 108, the infrared ray filter 105, the solid-state image sensing device module 103 are disposed along the optical axis.

In the compact camera 100, a light beam coming through the opening 107 is converged to the solid-state image sensing device module 103 by the condenser 108, and the light beam whose infrared rays were insulated by the infrared ray filter 105 forms an image on the solid-state image sensing device module 103, the solid-state image sensing device module 103 converts the received light beam into an electric signal, and the electric signal is converted into an image signal and output by the electronic component 102.

The solid-state image sensing device module 103 is preferably sensitive not only to visible light, but also to infrared rays, and thus, the received infrared rays may result in lowering of resolution or deterioration of image. Therefore, in order to avoid infrared rays from incoming into the solid-state image sensing device module 103, the infrared ray filter 105 is disposed on the light incoming side of the solid-state image sensing device module 103.

The current information technology devices are strongly required to be downsized. The compact camera is not exceptional, and further downsizing is required. Therefore, Japanese Unexamined Patent Application Publication No. 5-207350 proposes to provide a dielectric multilayer film constituting the infrared ray filter 105 directly on the lens 108, and eliminate the infrared ray filter 105 as a component so that downsizing is achieved.

However, the condenser 108 used in the compact camera is formed of plastic molded by injection molding in most cases for reducing weight and costs. When mounting the electronic components or the solid-state image sensing device module, a soldering process called “re-flow” in which solder is fused in a furnace heated at such a high temperature as about 290° C. is included. Since the plastic lens has no heat-resistance that can resist high temperatures in re-flow soldering, the lens is mounted after re-flow soldering process. Therefore, there arises a problem in that assembly productivity is lowered, and thus employment of glass lens is desired in terms of increase in efficiency of assembly.

The lens with an infrared ray filter proposed in the Patent Document 1 is a double-convex lens having convex surfaces on both sides. In order to fabricate such double-convex lens with glass, highly accurate fabricating technology is required since the optical axes of both surfaces must be aligned accurately when molding, which may result in a problem of cost overrun.

In addition, since film-formation of the dielectric multilayer film is a troublesome work including the steps of disposing a convex lens on a substrate support of a dome shape such as a vacuum evaporator one-by-one, performing vacuum evaporation, and taking the convex lens from the substrate support one-by-one, the cost for forming the film of the dielectric multilayer film may disadvantageously increase.

In view of such circumstances, it is an object of the present invention to provide a lens with an infrared ray filter in which the problem of cost overrun, which is caused when the lens with an infrared ray filter used for a condenser or the like in compact cameras is formed of glass, may be eliminated.

It is another object of the present invention to provide a method of manufacturing in which the glass lens with an infrared ray filter can be manufactured at a lower cost.

It is further an object of the present invention to provide a compact camera using a low-cost glass lens with an infrared ray filter.

### DISCLOSURE OF THE INVENTION

In order to achieve the objects described above, as a first aspect of the present invention, there is provided a lens with an infrared ray filter including an infrared ray insulating dielectric multilayer film for cutting infrared rays on one of the surfaces of a glass plane-convex lens having a flat refractive surface on one side and a convex refractive surface on the opposite side.

Since so-called plane-convex lens is employed, it is not necessary to align the optical axis regarding the flat refractive surface when molding the glass lens. Therefore, by using a mold including a plane surface on one of the opposed surfaces of cavities and a plane surface having a plurality of recesses for forming convexed refractive surfaces on the other one of the opposed surfaces of the cavities, a multi-cavity lens molding constructed of a plurality of continuously molded glass plane-convex lenses each having a flat refractive surface on one side and a convex refractive surface on the other side can be integrally molded. Therefore, since a number of lenses can be formed at once with a simple mold effectively, manufacture at a lower cost is realized.

Since the dielectric multilayer film is formed on the multi-cavity lens molding, the film may be formed on a number of lenses at once by a film-forming method such as vacuum evaporation. Therefore, the cost for forming the dielectric multilayer film may be reduced.

In addition, since the multi-cavity lens molding provided with the infrared ray insulating dielectric multilayer film is cut into an individual lens by dice cutting, a number of glass plane-convex lenses may be produced efficiently, and hence manufacture at a lower cost is realized.

As a second aspect, the present invention provides a lens with an infrared ray filter according to the first aspect described above, characterized in that the glass plane-convex lens is constructed in such a manner that projections constituting the convex surfaces of the convex lenses are formed integrally on one side of the flat plate.

The low-cost plane-convex lens obtained by cutting the multi-cavity lens molding including a plurality of projections having convex refractive surfaces of the convex lenses provided integrally on one side of the flat plate into individual projections by dice cutting is constructed in such a manner that the projections constituting the convex surfaces of the convex lenses are formed integrally on one side of the flat plate.

As a third aspect, the present invention provides a lens with an infrared ray filter according to the first or the second aspect described above, characterized in that the refractive surface of the convex surface is an axisymmetric aspherical surface in which the curvature radius decreases with the distance from the optical axis.

Since the convex lens of the-plane-convex lens is formed into such an axisymmetric aspherical shape, a convex lens of which various aberrations are suitably corrected may be obtained, and hence a favorable image may be obtained.

As a fourth aspect, the present invention provides a lens with an infrared ray filter according to the second aspect described above, characterized in that the geometric center of the contour of the flat plate coincides with the optical axis of the convex lens.

Since the geometric center of the contour of the lens coincides with the optical axis of the convex lens, when the lens is built in a compact camera or the like while aligning with the optical axis of the camera on the basis of the outer dimension of the lens, the optical axis of the lens is automatically aligned with the optical axis of the compact camera, and thus assembling work of the lens is easier in comparison with the case in which the lens is assembled so as to align the optical axis of the lens with the optical axis of the camera.

As a fifth aspect, the present invention provides a method of manufacturing a lens with an infrared ray filter including a molding step for molding a multi-cavity lens molding having a plurality of projections constituting refractive surfaces of the convex surfaces of the convex lenses formed integrally on the surface of the flat plate with glass, a film-forming step for providing an infrared ray insulating dielectric multilayer film for cutting the infrared rays on either one of the surfaces of the multi-cavity lens molding, and a cutting step for cutting the portions of the flat plate of the multi-cavity lens molding provided with the infrared ray insulating dielectric multilayer film into individual projections.

Since the multi-cavity lens molding including the plurality of continuously molded glass plane-convex lenses each having a flat refractive surface on one side and a convex refractive surface on the other side is integrally molded, a number of lenses can be formed at once with a simple mold effectively, and hence manufacture at a lower cost is realized.

Since a dielectric multilayer film is formed on the multi-cavity lens molding, the film may be formed on a number of lenses at once by a film-forming method such as vacuum evaporation. Therefore, the cost for forming the dielectric multilayer film may be reduced.

In addition, since the multi-cavity lens molding provided with the infrared ray insulating dielectric multilayer film is cut into an individual lens by dice cutting, a number of glass plane-convex lenses may be produced efficiently, and hence manufacture at a lower cost is realized.

As a sixth aspect, the present invention provides a method of manufacturing a lens with an infrared ray filter according to the fifth aspect described above, characterized in that the multi-cavity lens molding includes the projections being different in shape from each other.

Since the projections being different in shape from each other are provided on the single multi-cavity lens molding, many types of plane-convex lens may be formed in one molding operation.

As a seventh aspect, the present invention provides a method of manufacturing a lens with an infrared ray filter according to the fifth or sixth aspect described above, characterized in that alignment marks for aligning are transferred on the surface of the flat plate of the multi-cavity lens molding in the molding step.

Provision of the alignment marks enables accurate cutting into individual projections while aligning the optical axis of the lens with the geometrical center of the contour using the alignment marks as references representing the cutting position. Therefore, when assembling the obtained plane-convex lens into the compact camera, it can be assembled with reference to the contour, and thus assembling work may be facilitated.

As an eighth aspect, the present invention provides a method of manufacturing a lens with an infrared ray filter according to the seventh aspect described above, characterized in that the alignment mark is formed into a V-groove in cross section on the flat surface of the flat plate, and the cutting step is a step of cutting by a dicing blade so as to leave the portion in the vicinity of both edges of the V-groove.

When the alignment mark is provided for example at the corner of the multi-cavity lens molding, the portion provided with the alignment mark becomes an extra portion separate from the lens portion, and thus glass material is wasted. However, by forming the alignment mark along the cutting line, additional location for providing the alignment mark is not necessary, and thus waist of glass material is prevented.

Since the flat plate is -formed with the alignment mark being transferred -into the shape of V-groove in cross section on the flat surface thereof, and is cut from the side of projections by the dicing blade which is narrower than the width of the groove, the dicing blade cuts the flat plate along the tapered surface of the V-groove and thus chipping hardly occurs on the cut surface of the glass, whereby the yield ratio is increased.

As a ninth aspect, the present invention provides a compact camera including a solid-state image sensing device for converting the received light beam into an electric signal, a housing covering around the solid-state image sensing device and having an opening, and a lens with an infrared ray filter provided with an infrared ray insulating dielectric multilayer film for cutting the infrared rays on either one of the surfaces of the glass plane-convex lens including a flat refractive surface on one side and a convex refractive surface on the other side as the entire portion or a part of a lens system for converging the light beam coming through the opening onto the solid-state image sensing device.

Since the compact camera employs the lens with an infrared ray filter provided with the infrared ray insulating dielectric multilayer film, the infrared ray filter as a component may be eliminated, and thus downsizing may easily be realized. In addition, since a glass lens is employed, re-flow soldering may be performed with the lens mounted, and thus preferable assembling efficiency is achieved.

### BRIEF DESCRIPTION OF THE DRAWINGS

FIG. 1 shows a lens with an infrared ray filter according to the present invention, in which (a)-(c) are cross-sectional views, (d) is a plan view of the lens shown in (c).

FIG. 2 is a graph showing an example of a aspherical shape, in which (a) shows a change of curvature in the radial direction, and (b) shows a shape in the radial direction.

FIG. 3 shows an optical path of the spherical convex lens in (a) and an optical path of the aspherical convex lens in (b)

FIG. 4 is a graph showing various aberrations in an example of the aspherical convex lens.

FIG. 5 is a cross sectional view showing an example of a structure of a compact camera according to the present invention in which the lens with an infrared ray filter according to the present invention is employed.

FIG. 6 is a graph showing an example of a transmittance characteristic of the infrared ray insulating dielectric multilayer film formed on the lens with an infrared ray filter according to the present invention.

FIG. 7 from (1) to (5) are flowcharts showing a method of manufacturing the lens with an infrared ray filter according to the present invention, in which (a) is a plan view of an obtained lens, and (b) is a cross-sectional view of the obtained lens.

FIG. 8 is a plan view showing an example in which the projections of different shape are formed on one piece of multi-cavity lens molding.

FIG. 9 is a plan view of an example showing that the alignment marks are formed on the multi-cavity lens molding, in which (a) shows an example of the alignment marks provided at the corner, and (b) shows an example of the same formed along the cutting lines.

FIG. 10 from (a) to (d) are flowcharts showing a cutting method when forming the alignment mark of V-groove shape.

FIG. 11 is a cross-sectional view showing a construction of the conventional compact camera.

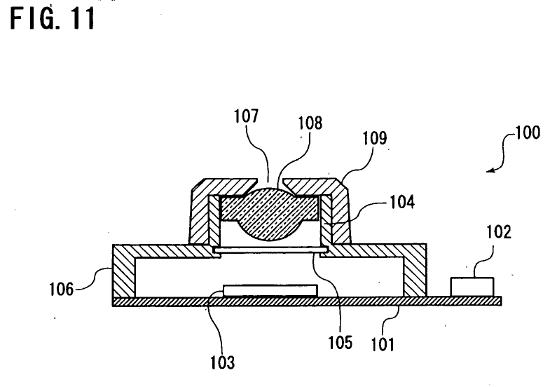

### DESCRIPTION OF THE PREFERRED EMBODIMENTS

Embodiments of a lens with an infrared ray filter and a method of manufacturing the same, and a compact camera according to the present invention will now be described. However, the present invention is not limited to the following embodiments.

The lens with an infrared ray filter according to the present invention is provided with an infrared ray insulating dielectric multilayer film for cutting the infrared rays on one of the surfaces of a glass plane-convex lens having a flat refractive surface on one side and a convex refractive surface on the opposite side.

The main intended use of the lens with an infrared ray filter according to the present invention is a condenser constituting the entire part or a part of a lens system for allowing the solid-state image sensing device such as a compact camera or a monitor camera to be built in information technology devices such as mobile phones, laptop personal computers, or PDA (Personal Digital Assistant) to form an image.

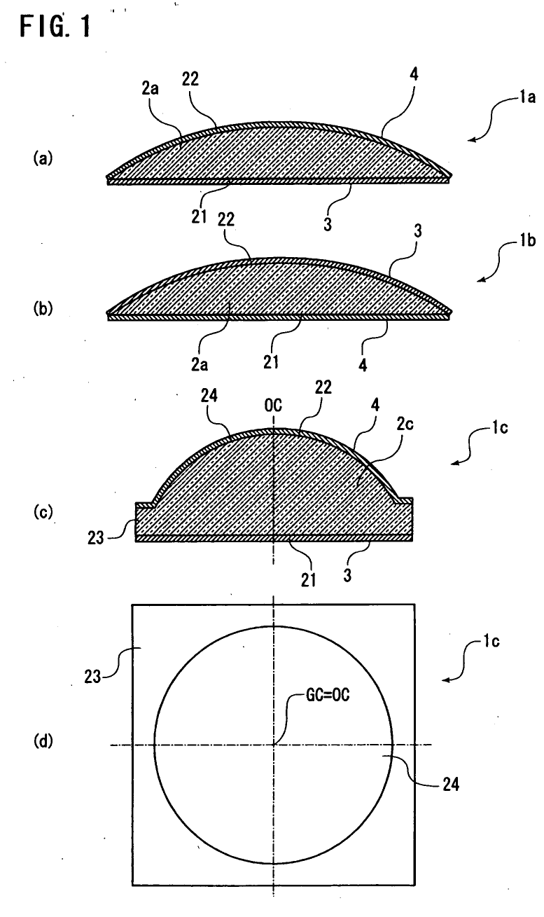

FIG. 1 shows a construction of the lens with an infrared ray filter according to the present invention. The lens with an infrared ray filter 1a shown in cross-sectional view in FIG. 1(a) is provided with an infrared ray insulating dielectric multilayer film 3 for cutting the infrared rays on a flat refractive surface 21 on one side of a general shaped glass plane-convex lens 2a, and a reflection reducing coating 4 on a convex refractive surface 22 on the opposite side. A lens with an infrared ray filter 1b shown in a cross-sectional view in FIG. 1(b) is provided with the reflection reducing coating 4 on the flat refractive surface 21 on one side of the general shaped glass plane-convex lens 2a, and the infrared ray insulating dielectric multilayer film 3 for cutting the infrared rays on the convex refractive surface 22 on the opposite side.

A lens with an infrared ray filter 1c shown in a cross-sectional view in FIG. 1(c) and in a plan view in FIG. 1(d) employs a glass plane-convex lens 2c formed with a dome-shaped glass projection 24 constituting the convex refractive surface 22 of the convex lens integrally on the center of one side of a substantially square shaped flat plate 23 formed of glass. The infrared ray insulating dielectric multilayer film 3 is provided on the flat surface of the flat plate 23 of the glass plane-convex lens 2c on which the projection is not provided, and the reflection reducing coating 4 is provided on the projection 24 and the surface of the flat plate 23 on the opposite side.

The glass plane-convex lens 2c is preferably constructed in such a manner that the geometrical center GC of the substantially square contour of the flat plate 23 coincides with the optical axis (optical center) OC of the convex lens 22. The term “coincide” does not mean “completely coincide”, but includes an allowable extent of error.

The lenses with an infrared ray filter 1a, 1b, 1c of such construction each have the infrared ray insulating dielectric multilayer film 4 on one surface. Therefore, the infrared ray filter as a component can be eliminated, and thus cost reduction and downsizing may be realized by reduction of the number of camera components.

The lenses with an infrared ray filter 1a, 1c shown in FIG. 1(a) and FIG. 1(c) each are provided with the infrared ray insulating dielectric multilayer film 3 for cutting the infrared rays on the flat refractive surface 21. Since the infrared ray insulating dielectric multilayer film 3 performs filtering operation using multiple interference between the layers, it significantly depends on the incident angles, and thus the efficiency of infrared rays insulation is lowered with increase in the incident angle. When an oblique ray comes into a convex surface, the incident angle of the ray with respect to the normal line of the convex surface is extremely large depending on the portion of the convex surface. In an extreme case, it may be coming up to a tangent line. However, when the oblique ray comes into a flat surface, the incident angle is constant irrespective of the portions. Therefore, by providing the infrared ray insulating dielectric multilayer film 3 for cutting the infrared rays on the flat refractive surface 21, dependency of the infrared ray insulating dielectric multilayer film 3 on the incident angle may be minimized.

Uniform formation of the infrared ray insulating dielectric multilayer film 3 on the curved surface having a large curvature radius is generally difficult. The lenses with an infrared ray filter 1a, 1c according to the present invention each are provided with the infrared ray insulating dielectric multilayer film 3 on the flat surface, the infrared ray insulating dielectric multilayer film 3 being superior in characteristics may be formed. The plane-convex lens on which the infrared ray insulating dielectric multilayer film 3 is provided is formed of glass material that can resist high temperatures. Unlike a lens whose deformation temperature is low as plastic, the glass plane-convex lens can be kept at a high temperature when forming the infrared ray insulating dielectric multilayer film 3 on the plane-convex lens by a physical film forming method. Therefore, formation of high quality infrared ray insulating dielectric multilayer films 3 is realized.

In addition, since it is a glass plane-convex lens, it can resist high temperatures in the soldering process called re-flow, in which solder is fused in a furnace heated to a high temperature, when mounting the electronic component or the solid-state image sensing device module. Therefore, re-flow soldering may be performed with the lens mounted to the compact camera. Therefore, efficiency of assembling process may be improved and thus a lower cost is realized.

Since the lens with an infrared ray filter 1c shown in FIGS. 1(c) and (d) can be manufactured by a manufacturing method according to the present invention that will be described later, it can be manufactured by a low-cost forming process and a low-cost film-forming process. Therefore, manufacture at a lower cost is realized.

The convex refractive surface 22 constituting a convex lens may be spherical surface or may be axisymmetric aspherical surface. In order to correct various aberrations suitably, the axisymmetric aspherical surface is preferable. The curved surface of the axisymmetric aspherical surface is generally represented by a high-degree polynominal equation (1) shown below.

$$[ Equation 1 ] \\ Z = \frac{{cr}^{2}}{1 + \sqrt{1 - ( 1 + K ) {c}^{2} {r}^{2}}} + {\sum }_{n} {A}_{n} {r}^{n} \qquad ( 1 )$$

where z represents a coordinate of the direction of the optical axis of the lens, r represents a coordinate from the optical axis in the radial direction of the lens, c represents a curvature at the apex of the lens, and K, Aₙ are aspherical coefficients.

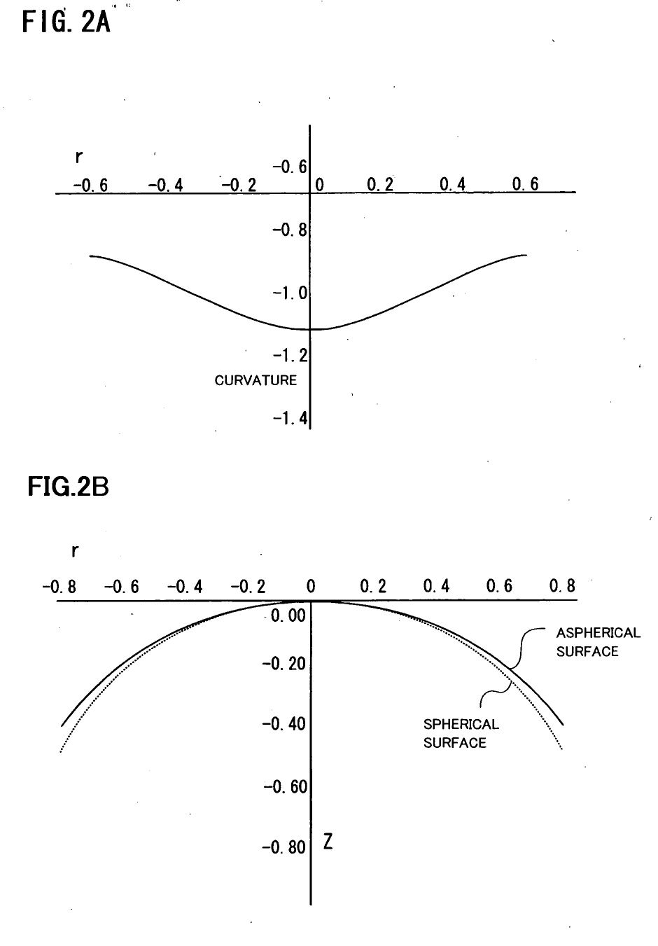

The curvature of axisymmetric aspherical surface preferably decreases with increase in distance from the optical axis, as shown in FIG. 2(a). As shown in FIG. 2(b), the shape of such axisymmetric aspherical surface shown by a solid line increases in distance from the spherical surface with the distance from the optical axis in comparison with the spherical surface shown by a broken line, and the amount of asphericity increases.

Glass material of refractive index N_{d}=1.5168 and Abbe number ν_{d}=64.2 is actually used, and a plane-convex lens 30 including a convex lens having a spherical refractive surface, and a plane-convex lens 1d including a convex lens having an axisymmetric aspherical refractive surface, both having a flat plate of 0.90 mm in thickness are assumed, and then the optical performances are compared. The curvature radius of the spherical surface is −0.8943. The respective coefficients of the aspherical surface of the axisymmetric aspherical surface are K=−0.06002, A₄=0.09393, A₆=0.04028, A₈=0.52930, A₁₀=0.38733, A₁₂=0.22400. The distance from the plane of the flat plate of the plane-convex lens to the aperture is 0.15 mm.

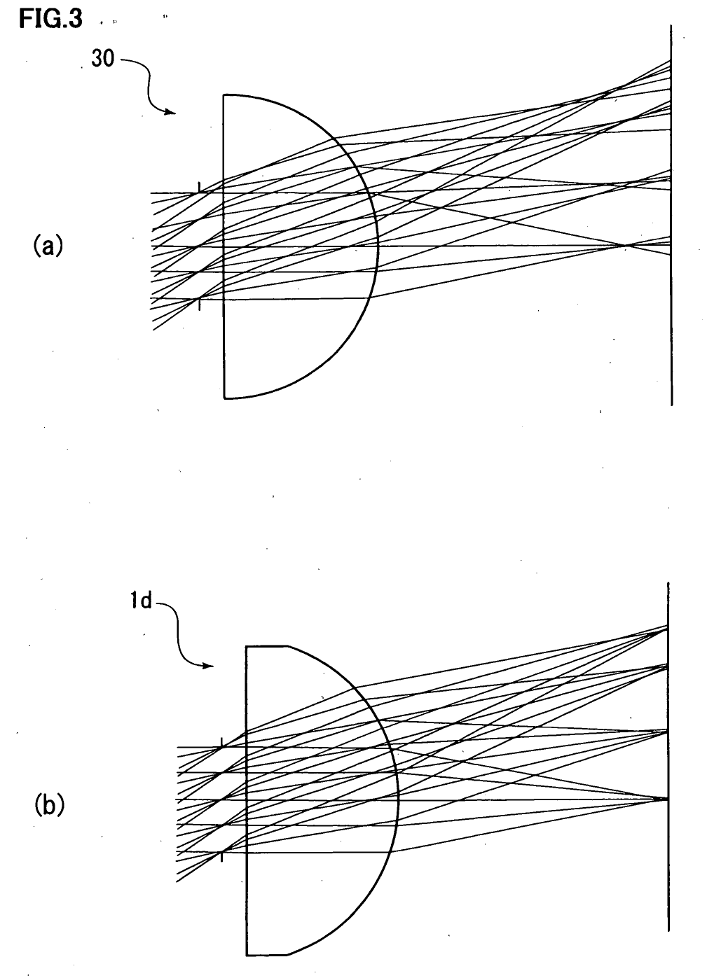

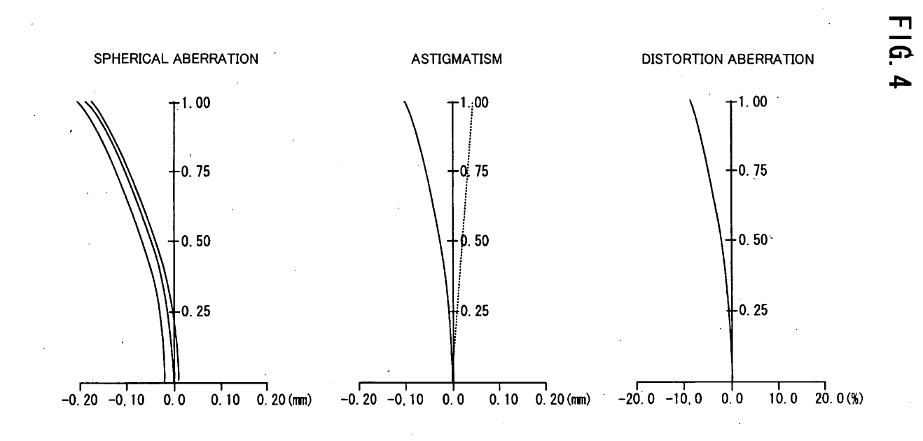

FIG. 3(a) shows a drawing of the optical path of the spherical lens 30 and FIG. 3(b) is a drawing showing the optical path of the axisymmetric aspherical lens 1d. The spherical aberration, astigmatism, and distortion aberration of the aspherical lens 1d are shown in FIG. 4. It is clear from FIG. 3(a) that light beams passed through the spherical lens 30 are diffused on a focal surface due to aberration, and the image is significantly out of focus.

In contrast, light beams passed through the axisymmetric aspherical lens 1d are well corrected in spherical aberration, astigmatism, distortion aberration, and so on as shown in FIG. 4, and as a consequence, as shown in FIG. 3(b), light beams are converged on the focal surface, and thus a desirable quantity of image can be obtained.

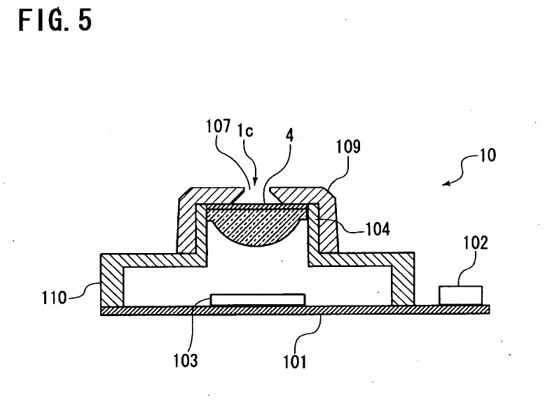

FIG. 5 shows a schematic cross-sectional construction of a compact camera 10 employing the lens with an infrared ray filter 1c according to the present invention as a condenser. The compact camera 10 includes an electronic component 102 and a solid-state image sensing device module 103 which are mounted on a substrate 101, and a housing 110 having a lens barrel 104 formed with a thread on the outer surface thereof is mounted to the substrate 101 so as to surround the solid-state image sensing device module 103. An outer cylindrical member 109 having an opening 107 which serves as aperture on one side, including a lens with an infrared ray filter 1c of the present invention built in as a condenser, and being formed with thread on the inner surface thereof is screwed into the thread formed on the outer surface of the lens barrel 104. By adjusting the amount of screw-in of the outer cylindrical member 109, the distance between the condenser 1c and the light receiving surface of the solid-state image sensing device module 103 can be adjusted, and it is fixed by means of adhesive agent after adjustment so as not to move. The opening 107, the lens barrel 104, the condenser 1c, and the solid-state image sensing device module 103 are disposed along the optical axis. Although a lens system of the compact camera 10 shown in FIG. 5 is constructed only of a condenser 1c, a lens other than the condenser 1c may be assembled, and the condenser 1c constitutes the entire or a part of the lens system.

The solid-state image sensing device module 103 is constructed of a micro lens, a color filter, and a solid-state image sensing device such as a CCD or a CMOS, not shown. The micro lens, the color filter, the solid-state image sensing device such as the CCD or the CMOS are arranged in matrix. The micro lens converges light beams converted by the condenser 1c onto the respective image sensing devices, the color filter separates the light beam into three primary colors, and the solid-state image sensing device converts the received light beam into an electric signal.

In the camera 10 shown in FIG. 5, the lens with an infrared ray filter 1c of the present invention is disposed as a condenser with the flat surface on which the infrared ray insulating dielectric multilayer film 3 is provided directed to the light incoming side, and the convex surface directed to the solid-state image sensing device module 103. In contrast, even when the lens is disposed with the convex surface directed toward the light incoming side and the flat surface on which the infrared ray insulating dielectric multilayer film 3 is provided directed to the solid-state image sensing device module 103, the function is not affected.

In the compact camera 10, the infrared ray insulating dielectric multilayer film 3 provided on the flat surface of the condenser 1c as a lens system insulates the infrared rays from the light beam incoming from the opening 107, the condenser 1c makes the light beam which is free from the infrared rays to form an image on the solid-state image sensing device module 103, the solid-state image sensing device module 103 converts the received light beam into an electric signal, and the electronic component 102 converts the electric signal to an image signal and outputs the same.

The lens with an infrared ray filter 1c as a condenser has a function to insulate the infrared rays in addition to a function as a lens. Therefore, the infrared ray filter as a component may be eliminated from the compact camera 10. As a consequence, cost reduction and downsizing are realized. In addition, since the condenser 1c is formed of glass, re-flow soldering may be performed with the condenser 1c assembled. Therefore, efficiency of the assembling process may be improved. Furthermore, since the flat surface of the condenser 1c may be brought into intimate contact with the opening 107 of the outer cylindrical member 109, dust-resistant device for the opening 107 is not specifically required.

In addition, in the lens with an infrared ray filter 1c, as shown in FIG. 1(d), the geometrical center GC of the contour coincides with the optical axis OC of the convex lens 22. Therefore, the optical axis of the convex lens can be aligned with the optical axis of the compact camera 10 by assembling the lens with an infrared ray filter 1c to the outer cylindrical member 109 on the basis of the outer dimension. Therefore, by forming a structure for positioning such as a recess in which the flat plate 23 of the lens with an infrared ray filter 1c is fitted, alignment of the optical axis can be achieved only by fitting the lens with an infrared ray filter 1c into the recess. Therefore, assembling efficiency is significantly improved. If the geometrical center GC of the contour does not coincide with the optical axis OC of the convex lens, the optical axis must be aligned for each and every lens when assembling the lens, and thus the assembling work becomes complex and thus productivity is lowered.

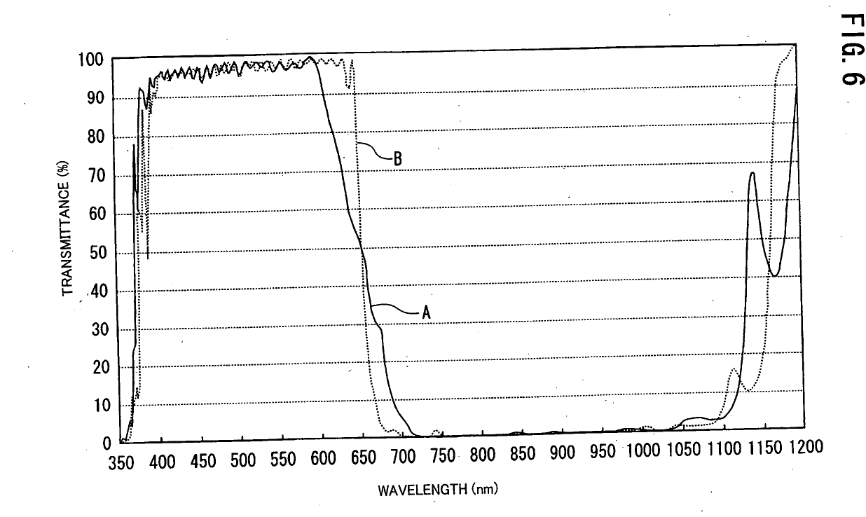

FIG. 6 shows an example of the transmittance characteristics of the infrared ray insulating dielectric multilayer film 3 provided on one side of the lens with an infrared ray filter according to the present invention. In FIG. 6, the transmittance characteristics of two types of infrared ray insulating dielectric multilayer films are shown by a solid line A and a broken line B.

The transmittance characteristic A and the transmittance characteristic B are common in that a transmittance of almost above 95% is exhibited in the region of visible light between 400 to 600 nm, in that the mesial magnitude is about 650 mm, and in that it can be almost insulated in the infrared region between 725 to 1000 nm.

However, the transmittance characteristic A is moderate in inclination of the falling characteristic in the vicinity of 650 nm in comparison with the transmittance characteristic B. More specifically, the width of the wavelength when the transmittance is reduced from 90% to 10% in the range of mesial magnitudes between 600 and 700 nm is preferably at least 40 nm, particularly at least 50 nm, most preferably at least 60 nm and not more than 100 nm. By making the falling characteristic in the vicinity of the mesial magnitude moderate as the transmittance characteristic A, the transmittance characteristic which is close to the visual apprehension spectral sensitivity which shows the sensitivity of actual eyes is achieved by reducing the intensity of visual light on the long wavelength side.

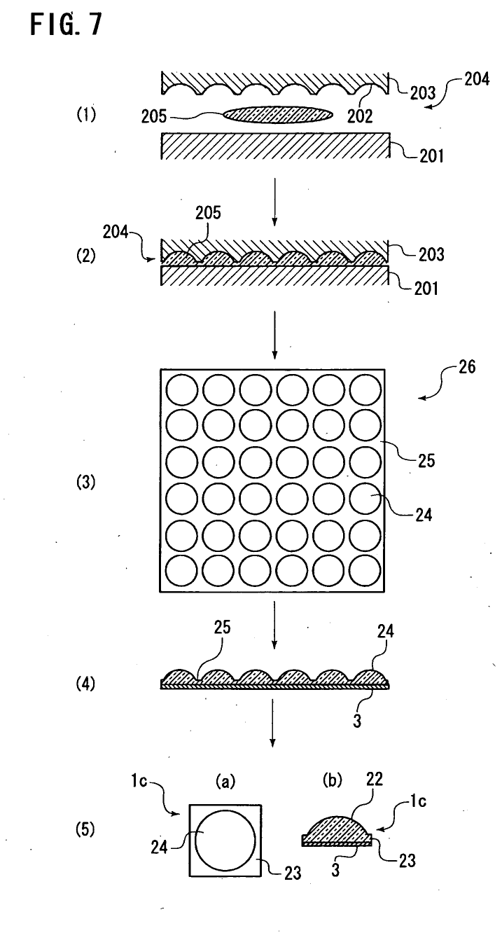

Subsequently, referring a flowchart in FIG. 7, a method of manufacturing a lens with an infrared ray filter according to the present invention will be described. As shown in FIG. 7(1), a multi-cavity lens molding 204, in which one of two molds each constituting a cavity when closed is a flat mold 201 whose surface constituting the cavity is flat, and the other mold is a dimple mold 203 whose plurality of recessed surfaces 202 forming the convex refractive surface of the lens are formed on the flat surface, is employed as a molding mold. The cavity formed when the dimple mold 203 and the flat mold 201 are mated has a shape where projections are arranged in matrix on a flat plate. The recessed surface of the dimple mold 203 is preferably a shape where the axisymmetric aspherical surface as described above can be transferred.

In the molding process, as shown in FIG. 7(1), the molds 201 and 203 are opened and melted optical glass material 205 is filled in the cavity. The optical glass material 205 is selected considering the refractive index and Abbe number.

Subsequently, as shown in FIG. 7(2), the flat mold 201 and the dimple mold 203 are closed to develop the optical glass material 205 in the cavity, and in this state, the glass material 205 is cooled and solidified. The molding having transferred with the shape of the cavity has a shape where the projections 24 are arranged in matrix on a large flat plate 25 as shown in FIG. 7(3), and is a multi-cavity lens molding 26 in which the portions between the respective convex lenses 24 are connected by the flat plate 25.

Subsequently, as shown in FIG. 7(3), the molds 201, 203 are opened to take out the finished multi-cavity lens molding 26. Then, as shown in FIG. 7(4), the infrared ray insulating dielectric multilayer film 3 is formed on one side of the multi-cavity lens molding 26 and a reflection reducing coating, not shown, is formed on the other side thereof.

The infrared ray insulating dielectric multilayer film 3 has a construction in which layers having high refractive index and layers having low refractive index are laminated alternately on the multi-cavity lens molding 26.

Material used for the high refractive index layer constituting the infrared ray insulating dielectric multilayer film 3 includes TiO₂ (n=2.4), Ta₂O₅ (n=2.1), Nb₂O₅ (n=2.2), ZrO₂ (n=2.05), Ta₂O₅ (n=2.1) and so on, and material used for the low refractive index layer includes SiO₂ (n=1.46), Al₂O₃ (n=1.63), MgF₂ (n=1.38) and so on. The refractive index differs depending on the wavelength, and the refractive index n is a value of 500 nm.

The basic design regarding the film thickness is represented generally as (0.5H, 1L, 0.5H)^{s} as repetitive alternate layers in which the layers having high refractive index and the layers having the low refractive index, being uniform in optical thickness, are repetitively laminated alternately. Here, the wavelength near the center of the wavelengths which are required to be insulated is represented by a design wavelength λ, the thickness of the film of the high refractive index layer (H) is represented by 1H by the optical thickness of the film (nd)=¼λ, and likewise, the layer having a low refractive index (L) is represented by 1L. The reference sign S represents the number of times of repetition called as stack number, which means that the construction in parenthesis is repeated periodically. The number of, layers actually laminated will be 2S+1 layers, and the larger the value of S is, the steeper the rising characteristic (rapidness) changing from reflection to transmission becomes. The value of S is selected from the range in the order from 3 to 20. The specific wavelength to be insulated is determined by these repetitive alternate layers.

In order to increase the transmittance in the transmitting band, and to change unevenness of optical transmittance called ripple into a flat characteristic, optimal design is achieved by changing the thickness of a couple of layers of the repetitive alternate layers located in the vicinity of the substrate and in the vicinity of a medium. Therefore, it is represented as Substrate |0.5LH . . . HL(HL)^{s} HL . . . H, 0.5L. When using TiO₂ in the high refractive index layer, SiO₂, which is superior in environment resistant characteristics, is added in design as the outermost layer in many cases instead of using the high refractive index layer as the outermost layer. Since the layer that is in contact with the substrate may be deteriorated in characteristic due to reaction of TiO₂ with the substrate, the SiO₂, which is chemically stable, may be added to the first layer. The design of multilayer film cut filter may be theoretically implemented using commercially available software (Reference: OPTRONICS magazine, 1999, No. 5, p.175-190)

In order to form the high refractive index layers and the low refractive index layers alternately on the light transmitting substrate, a physical film forming method is generally employed. Though the normal vacuum evaporating method is also applicable, it is desirable to employ ion assist evaporation, ion plating, or sputter deposition, which can control the refractive index of the film stably and can form a film which is less subjected to change of spectral characteristic with time due to change of storage and specification environment. The vacuum evaporation method is a method of forming a thin film by heating and evaporating a thin film material in high vacuum environment, and accumulating these evaporated particles on the substrate. The ion plating is a method of ionizing the evaporated particles, and accelerating them by electric field to attach them on the substrate, and includes an APS (Advanced Plasma Source), an EBEP (Electron Beam Excited Plasma) method, a RF (Radio Frequency) direct substrate application method (a method of performing reactive vacuum evaporation in a state in which a high-frequency gas plasma is generated in a film-forming chamber). The sputter deposition is a method of forming a thin film by allowing a thin film material to evaporate by sputtering which allows ion accelerated by electric field to impinge on the thin film material for sputtering the thin film material, and allowing the evaporated particles to be accumulated on the substrate. Since the optical constant such as a refractive index of a layer to be formed varies depending on the film forming method or the film forming conditions, it is required to measure the optical constant of a layer to be formed accurately before manufacture.

The reflection reducing coating is constructed of a single layer or multiple layers of inorganic coating or organic coating. A multilayer construction including the inorganic coating and the organic coating may also be applicable. Material of the inorganic coating includes inorganic substances such as SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, WO₃, and so on. These substances may be used independently, or in combination of two or more of those. Since the lens with an infrared ray filter of the present invention is formed of heat-resistant glass as basic material, the type of material to be used for the inorganic coating is not specifically limited. When the multilayer construction is employed, the outermost layer is preferably formed of SiO₂.

As the multiple-layer film of the inorganic coating, a four-layer construction including, from the base material side, ZrO₂ layer and SiO₂ layer whose total optical film thickness is λ/4, ZrO₂ layer whose optical film thickness is λ/4, and the uppermost SiO₂ layer whose optical film thickness is λ/4 may be exemplified. The sign λ used here represents a design wavelength, which is normally 520 nm.

The method of forming a film of the inorganic coating that can be employed here includes, for example, vacuum evaporation, ion plating, sputter deposition, CVD method, a method of separating out by a chemical reaction in saturated solution.

The organic coating may be formed, for example, of FFP (copolymer of tetrafluoroethylene-hexafluoropropylene), PTFE (Polytetrafluoroethylene), ETFE (copolymer of ethylene-tetrafluoroethylene), and is selected considering the refractive index of cover glass base material or the hard coat film. It may be formed by coating methods which are superior in terms of mass production such as a spin coating method, a dip coating method as well as the vacuum evaporation method.

After the infrared ray insulating dielectric multilayer film 3 and the reflection reducing coating have formed, as shown in FIG. 7(5), the flat plate 25 is cut between the respective convex lenses 24 by a dicing blade of a dicing apparatus, not shown, in the cutting process so as to be separated into individual plane-convex lens. Consequently, the lens with an infrared ray filter 1c according to the present invention shown in FIGS. 1(c) and (d) may be obtained.

According to the method of manufacturing a lens with an infrared ray filter as describe above, the multi-cavity lens molding 26 in which the plurality of projections constituting the refractive surfaces of the convex surfaces of the convex lens are provided integrally on the surface of the flat plate may be formed integrally. Since one of the surfaces of the plane-convex lens is a flat plane and thus axial alignment with the convex surface is not necessary, such multi-cavity lens molding 26 may be molded. Therefore, a number of lenses may be molded effectively at once with a simple mold, and thus manufacture at a lower cost is achieved.

In addition, since the dielectric multilayer film is formed on the integrally molded multi-cavity lens molding, carrying in, installation, and carrying out from the film forming apparatus may be performed quickly, and hence productivity is improved, the costs for forming the dielectric multilayer film may be reduced.

The multi-cavity lens molding 204 may be constructed in such a manner that a plurality of types of convex lenses are formed into the single multi-cavity lens molding 26 by varying the shapes of the recessed surfaces of the dimple mold 203 from one another so that the surface configurations of the projections 24 are different from each other. In order to differentiate the shapes of the convex lens, the shape or the outer diameter of the aspherical surface may be changed.

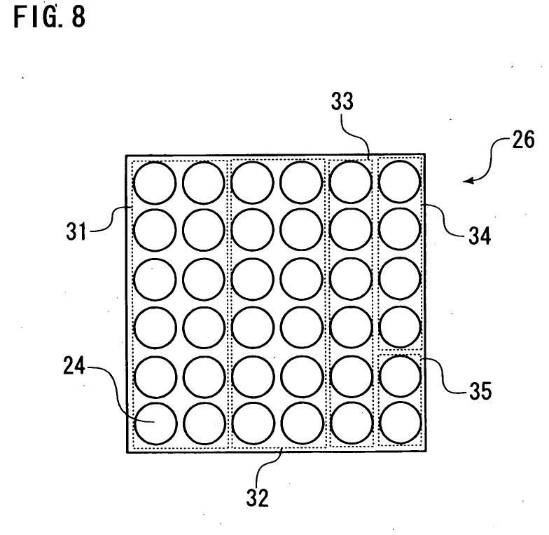

As shown in FIG. 8, for example, by forming the projections in the region shown by a broken line 31 into convex lenses of a first aspherical shape, forming the projections in the region shown by a broken line 32 into convex lenses of a second aspherical shape, forming the projections in the region shown by a broken line 33 into convex lenses of a third aspherical shape, forming the projections in the region shown by a broken line 34 into convex lenses of a fourth aspherical shape, and forming the projections in the region shown by a broken lines 35 as convex lenses of a fifth aspherical shape, five different designs of convex lenses may be formed into the single multi-cavity lens molding 26. Then, by cutting it into individual projections, a number of types of plane-convex lens may be formed in one molding operation.

The multi-cavity lens molding 204 may be formed with alignment marks required for positioning in the cutting process, and hence the alignment marks are formed on the flat plate 25 of the multi-cavity lens molding 26 by transfer operation.

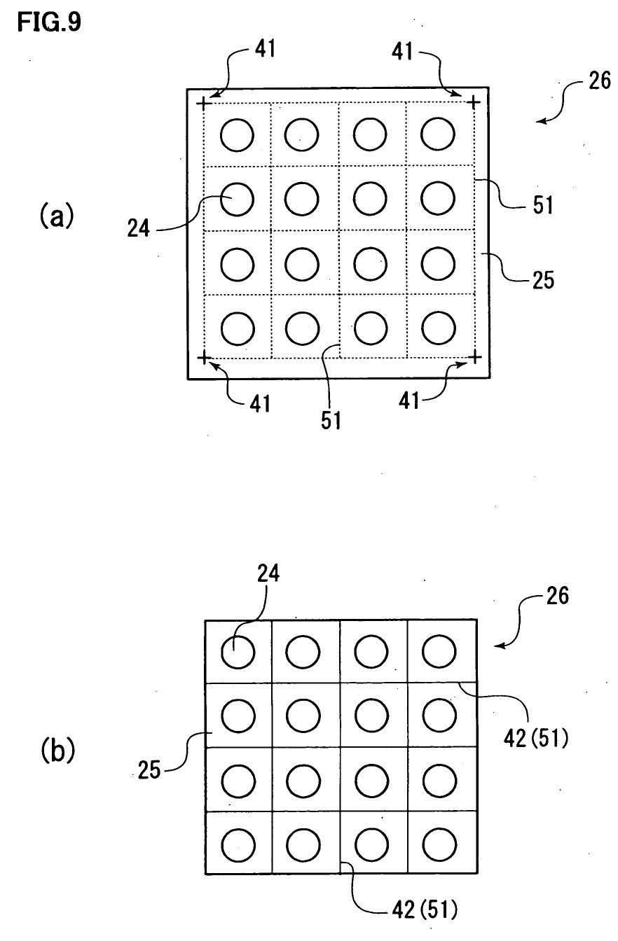

As shown in FIG. 9(a), a margin is formed on the outer periphery of the flat plate of the multi-cavity lens molding 26 as the portions required as lenses, and cross-shaped alignment marks 41 may be formed at least at two corners of the margin by transfer operation from the mold. In this case, the mold for transferring the alignment mark 41 may be the flat mold 201 or the dimple mold 203. The transferred alignment mark 41 may be either of a projecting shape or a groove shape.

With the provision of the alignment marks 41 on the multi-cavity lens molding 26, it can be cut into individual convex lenses automatically and accurately by dicing apparatus, not shown. An alignment mark detecting unit provided on the dicing apparatus, not shown, takes a picture of the multi-cavity lens molding 26 on which an adhesive tape is adhered on the flat surface, from above by an image sensing device such as a CCD or the like and detects the alignment mark 41 from the obtained image data. Subsequently, the dicing apparatus programs cutting lines 51 as shown by broken lines in FIG. 9(a) to be cut by the dicing apparatus so that the optical axes of the projections coincide respectively with their geometrical centers of the contours thereof using the alignment mark 41 as reference points of the dicing coordinate, and cuts automatically along the cutting lines 51 by the dicing blade.

Since there are provided the margin on the outer periphery of the flat plate 25, in the case of the alignment marks 41 shown in FIG. 9(a), the portions at which the alignment marks 41 are formed come to have some useless margin. Therefore, as shown in FIG. 9(b), by forming alignment marks 42 along the cutting lines 51, such useless margin may be avoided.

When the alignment marks 42 are formed along the cutting lines 51, the mold for transferring the alignment marks 42 may be either of the dimple mold 203 or the flat mold 201. However, in order to prevent occurrence of chipping when dicing, a projection that can transfer a V-groove having a width slightly wider than the width of the dicing blade is preferably formed on the flat mold 201.

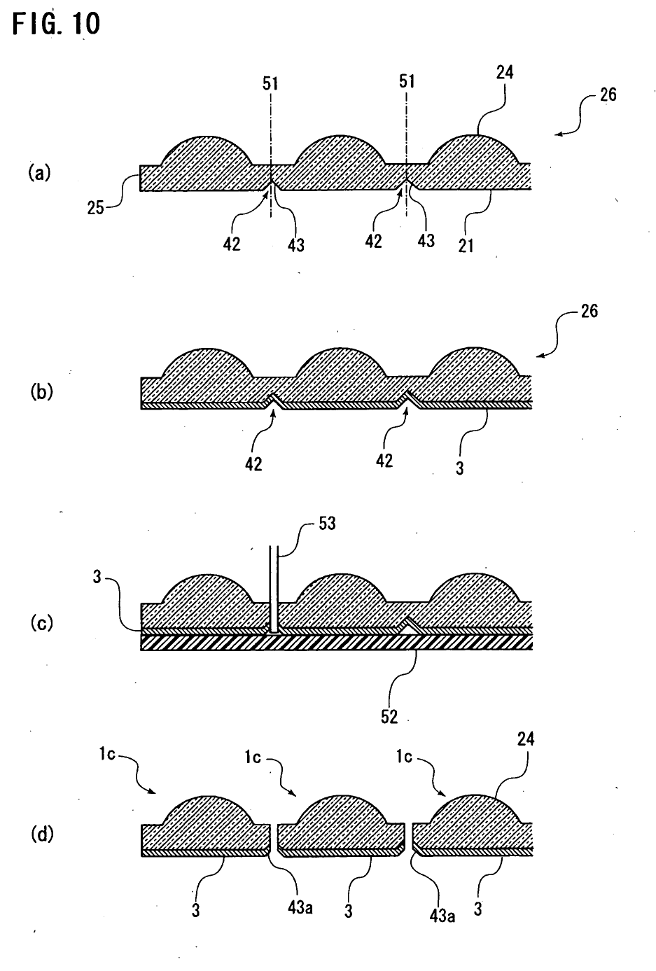

FIG. 10 is a flowchart showing a cutting process when the alignment marks in the shape of a V-groove are formed along the cutting lines on the flat surface of the flat plate.

As shown in FIG. 10(a), the multi-cavity lens molding 26 is formed with the alignment marks 42 in the shape of V-groove 43 on the flat surface of the flat plate 25 by transfer from the flat mold 201. The bottom center of the V-groove 43 of the alignment mark 42 at an acute angle coincides with the cutting line 51 to be cut so that the geometrical center of the contour coincides with the optical axis of the convex lens. The maximum width of the V-groove 43 is slightly wider than the dicing blade.

As shown in FIG. 10(b), the infrared ray insulating dielectric multilayer film 3 is provided on the flat surface of the multi-cavity lens molding 26.

As shown in FIG. 10(c), the multi-cavity lens molding 26 includes an adhesive tape 52 being adhered on the flat surface thereof and is installed in the dicing apparatus, not shown. The dicing apparatus takes a picture of the multi-cavity lens molding from above with the image sensing device such as the CCD, the alignment marks 42 are detected from the obtained image data, and programs the center of the detected alignment mark 42 as the cutting line 51. Then, the dicing apparatus cuts automatically along the centerline (cutting line 51) of the alignment mark 42 by a dicing blade 53 from the convex lens side. In this case, the width of the dicing blade 53 is narrower than the maximum width of the V-groove 43, it is possible to dice with the distal edge of the dicing blade 53 projected into the V-groove 43 so that the distal edge of the dicing blade 53 does not reach an adhesive tape 52. By removing the respective convex lens from the adhesive tape 52 after the individual projections are cut off by dicing operation, the lenses are divided into the individual lenses 1c as shown in FIG. 10(d). Since the width of the dicing blade 53 is smaller than the maximum width of the V-groove 43, the portion of the V-groove 43 in the vicinity of both end edges remains in the shape of a chamfer 43a.

According to the dicing operation as described above, the tip of the dicing blade 53 enters into the V-groove 43 and cuts the flat plate. When the tip of the dicing blade cuts the glass plate at once, there is a case in which chipping may occur on the cut surface when the tip of the dicing blade 53 breaks the flat surface of the glass plate. In the above-described dicing operation, since the dicing blade 53 cut the tapered V-groove 43, the cut surface can hardly be chipped. Therefore, generation of defective goods may be prevented and hence the yield ratio is increased.

Since the adhesive tape 52 is not diced, attaching of adhesive agent of the adhesive tape 52 to the dicing blade 53 may be prevented and thus disadvantage such as damage or contamination of the plane-convex lens 1c due to attachment of the glass chips can be avoided.

Since the V-groove 43 described above brings about the effects described above if the cross section thereof is substantially V-shape, modification of the V-shape is acceptable.

Industrial Applicability

A lens with an infrared ray filter according to the present invention can be used as a condenser for compact cameras used in mobile telephone or the like.

A method of manufacturing the lens with an infrared ray filter according to the present invention can manufacture the lens with an infrared ray filter that can be used as a condenser for compact cameras used in mobile telephones or the like.

A compact camera according to the present invention may be used, for example, in mobile telephones.

What is claimed is:

1. A lens with an infrared ray filter comprising an infrared ray insulating dielectric multilayer film for cutting infrared rays on one of the surfaces of a glass plane-convex lens having a flat refractive surface on one side and a convex refractive surface on the opposite side.

2. A lens with an infrared ray filter according to claim 1, characterized in that the glass plane-convex lens is constructed in such a manner that projections constituting the convex surfaces of the convex lenses are formed integrally on one side of the flat plate.

3. A lens with an infrared ray filter according to claim 1 or claim 2, characterized in that the refractive surface of the convex surface is an axisymmetric aspherical surface in which the curvature radius decreases with the distance from the optical axis.

4. A lens with an infrared ray filter according to claim 2, characterized in that the geometric center of the contour of the flat plate coincides with the optical axis of the convex lens.

5. A method of manufacturing a lens with an infrared ray filter comprising:
a molding step for molding a multi-cavity lens molding having a plurality of projections constituting refractive surfaces of the convex surfaces of the convex lenses formed integrally on the surface of the flat plate with glass;
a film-forming step for providing an infrared ray insulating dielectric multilayer film for cutting the infrared rays on either one of the surfaces of the multi-cavity lens molding; and
a cutting step for cutting the portions of the flat plate of the multi-cavity lens molding provided with the infrared ray insulating dielectric multilayer film into individual projections.

6. A method of manufacturing a lens with an infrared ray filter according to claim 5, characterized in that the multi-cavity lens molding includes the projections being different in shape from each other.

7. A method of manufacturing a lens with an infrared ray filter according to claim 5 or claim 6, characterized in that alignment marks for aligning are transferred on the surface of the flat plate of the multi-cavity lens molding in the molding step.

8. A method of manufacturing a lens with an infrared ray filter according to claim 7, characterized in that the alignment mark is transferred along cutting lines to be cut in the cutting step on the flat surface of the flat plate into a V-groove in cross-section, and the cutting step is a step of cutting by a dicing blade so as to leave the portion in the vicinity of both edges of the V-groove.

9. A compact camera comprising:
a solid-state image sensing device for converting the received light beam into an electric signal;
a housing covering around the solid-state image sensing device and having an opening; and
a lens with an infrared ray filter provided with an infrared ray insulating dielectric multilayer film for cutting the infrared rays on either one of the surfaces of the glass plane-convex lens including a flat refractive surface on one side and a convex refractive surface on the other side as the entire portion or a part of a lens system for converging the light beam coming through the opening onto the solid-state image sensing device.
